(19) United States
(12) Patent Application Publication
(10) Pub. No.: US 2007/0070262 A1
(43) Pub. Date: Mar. 29, 2007

(54) Liquid crystal display with curving data lines

(75) Inventors: Chao Yi Hung, Miao-Li (TW); Tsau Hua Hsieh, Miao-Li (TW); Hung Yu Chen, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/526,496

(22) Filed: Sep. 25, 2006

(30) Foreign Application Priority Data
Sep. 23, 2005 (TW) 94216417

(51) Int. Cl. G02F 1/136

(52) U.S. Cl. 349/43

(57) ABSTRACT

A liquid crystal display (100) includes a liquid crystal panel having a plurality of gate lines (GL1˜GLn) that are parallel to each other and that each extend along a first direction, and a plurality of data lines (DL1˜DLm+1) that are parallel to each other and that each extend along a second direction substantially orthogonal to the first direction, a plurality of pixel regions (130) defined by points of intersection of the gate lines and the data lines, and a gate driver (140) for driving the gate lines, and a data driver (160) for driving the data lines. Each of the data lines includes curving portions, such that each of the pixel regions defined by two corresponding data lines has two curved side boundaries.

### CROSS-REFERENCE TO RELATED APPLICATION

This application is related to the application entitled LIQUID CRYSTAL DISPLAY WITH CURVING DATA LINES filed before the present application, and assigned to the same assignee as the present application.

### FIELD OF THE INVENTION

The present invention relates to liquid crystal displays (LCDs), and more particularly to an active matrix type liquid crystal display.

### BACKGROUND

Because LCD devices have the advantages of portability, low power consumption, and low radiation, they have been widely used in various portable information products such as notebooks, personal digital assistants (PDAs), video cameras, and the like. Furthermore, LCD devices are considered by some to have the potential to completely replace CRT (cathode ray tube) monitors and televisions.

FIG. 3 is an abbreviated diagram of certain parts of a conventional active matrix LCD, including circuitry thereof. The active matrix LCD 10 provides a display driven by a dot inversion method, with data lines 16 of the active matrix LCD 10 being driven by a column inversion method. Therefore the active matrix LCD 10 is capable of consuming a relatively small amount of power during its operation.

The data lines 16 and gate lines 14 in the active matrix LCD 10 are straight lines that cross each other and accordingly define pixel regions of the active matrix LCD 10 that are rectangular in shape. The pixel regions are thus arranged in a regular matrix of rows and columns. Accordingly, the boundary between each two adjacent rows of pixel regions and each two adjacent columns of pixel regions is relatively sharp and clear. Therefore the active matrix LCD 10 is liable to exhibit an undesired visual boundary effect when the display screen is viewed while displaying images.

Accordingly, what is needed is an active matrix LCD that can overcome the above-described deficiencies.

### SUMMARY

A liquid crystal display includes a liquid crystal panel having a plurality of gate lines that are parallel to each other and that each extend along a first direction, and a plurality of data lines that are parallel to each other and that each extend along a second direction substantially orthogonal to the first direction, a plurality of pixel regions defined by points of intersection of the gate lines and the data lines, and a gate driver for driving the gate lines, and a data driver for driving the data lines. Each of the data lines includes curving portions, such that each of the pixel regions defined by two corresponding data lines has two corresponding curved side boundaries.

With this configuration, each two adjacent pixel regions in a row are partially staggered, which may weak the impact of the boundary effect therebetween and enable the active matrix LCD obtain better display quality.

Other advantages and novel features will become more apparent from the following detailed description when taken in conjunction with the accompanying drawings.

### BRIEF DESCRIPTION OF THE DRAWINGS

FIG. 1 is an abbreviated diagram of certain parts of an active matrix LCD including circuitry thereof according to an exemplary embodiment of the present invention, the LCD including a multiplicity of pixel regions.

FIG. 2 is similar to FIG. 1, but showing the LCD with filter elements applied to the pixel regions.

FIG. 3 is an abbreviated diagram of certain parts of a conventional active matrix LCD, including circuitry thereof.

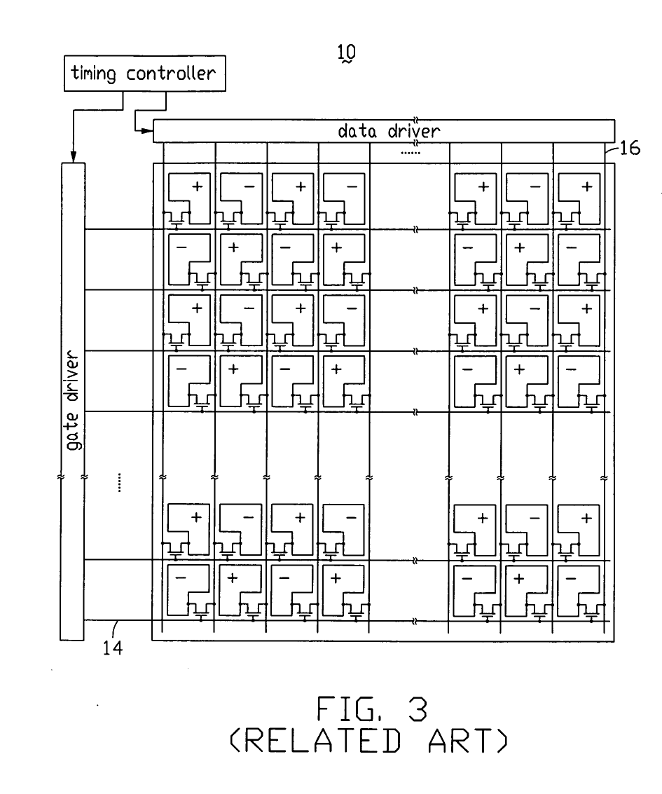

### DETAILED DESCRIPTION OF PREFERRED EMBODIMENTS

Reference will now be made to the drawings to describe the present invention in detail.

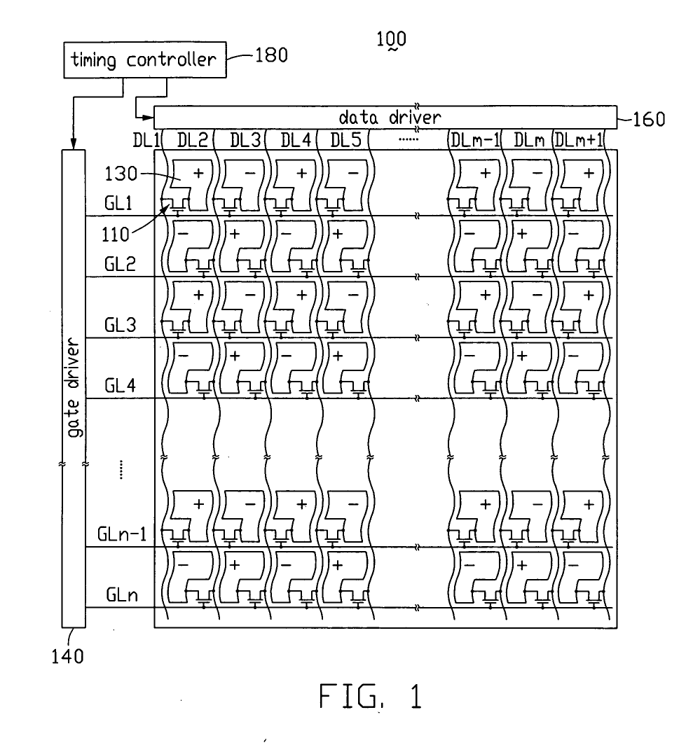

FIG. 1 is an abbreviated diagram of certain parts of an active matrix LCD including circuitry thereof according to an exemplary embodiment of the present invention. The active matrix LCD 100 includes a liquid crystal panel (not shown). The liquid crystal panel includes a gate driver 140 for driving gate lines GL1 to GLn arranged in a first glass substrate (not shown) of the liquid crystal panel, a data driver 160 for driving data lines DL1 to DLm+1 also arranged in the first glass substrate, and a timing controller 180 for controlling the gate and data drivers 140 and 160 respectively.

The gate lines GL1 to GLn and the data lines DL1 to DLm+1 cross each other but are insulated from each other. Pixel regions 130 of the active matrix LCD 100 are arranged in a matrix pattern, the matrix pattern being defined by points of intersection of the gate lines GL1 to GLn and the data lines DL1 to DLm+1. Each pixel region 130 may include a thin film transistor (TFT) 110 connected to a corresponding one of the gate lines GL1 to GLn and to a corresponding one of the data lines DL1 to DLm+1.

In each column of TFTs 110, successive TFTs 110 are alternately connected left and right to two corresponding consecutive data lines DL. Thus each row of TFTs 110 connected to an odd-numbered gate line GL has a same pattern of connections, and each row of TFTs 110 connected to an even-numbered gate line GL has a same pattern of connections. For example, each row of TFTs 110 connected to a respective one of the odd-numbered gate lines GL1, GL3, GL5, etc. has a total of m TFTs 110. The m TFTs 110 are connected to the first through m^{th} data lines DL1 to DLm. The gate line connection of each TFT 110 is from a terminal of the TFT 110 to the corresponding gate line GL. Each row of TFTs 110 connected to a respective one of the even-numbered gate lines GL2, GL4, GL6, etc. has a total of m TFTs 110. The m TFTs 110 are connected to the second through (m+1)^{th} data lines DL2 to DLm+1. The gate line connection of each TFT 110 is from a terminal of the TFT 110 to the corresponding gate line GL.

In operation, the gate driver 140 scans and sequentially applies gate signals to the gate lines GL1 to GLn to drive the TFTs 110. At the same time, the data driver 160 supplies video signals to corresponding driven TFTs 110 in order to modulate the orientation of liquid crystal molecules (not shown) included within the respective pixel regions 130. Accordingly, because the respective light transmittances of the individual pixel regions 130 in the active matrix LCD 100 are individually controlled, the active matrix LCD 100 may display images.

The data driver 160 may supply video signals to the data lines DL1 to DLm+1 using a column inversion driving method. In the following exemplary description of this method, the first, third, etc. pixel regions 130 in each row of pixel regions 130 are defined as odd-numbered pixel regions 130; and the second, fourth, etc. pixel regions 130 in each row of pixel regions 130 are defined as even-numbered pixel regions 130. Thus for example, in a first horizontal period when the first gate line GL1 is driven, video signals having a positive polarity applied from the data driver 160 may be supplied to the odd-numbered pixel regions 130 connected to the odd numbered data lines DL1, DL3, etc., while video signals having a negative polarity applied from the data driver 160 may be supplied to the even-numbered pixel regions 130 connected to the even-numbered data lines DL2, DL4, etc. Subsequently, in a second horizontal period, the second gate line GL2 is driven, and the data driver 160 shifts the video signals applied in the first horizontal period to the right by one channel. Accordingly, video signals having a negative polarity may be supplied to the odd numbered pixel regions 130 connected to the even numbered data lines DL2, DL4, etc., and video signals having a positive polarity may be supplied to the even numbered pixel regions 130 connected to the odd numbered data lines DL3, DL5, etc. (with the exception of the first data line DL1). In this way, the data driver 160 drives the data lines DL1 to DLm+1 by the column inversion method, with the pixel regions 130 of the active matrix LCD 100 being driven by a dot inversion method.

Advantageously, each of the data lines DL1 to DLm+1 includes curving portions, whereby the data lines DL1 to DLm+1 are wavy. Therefore each column of pixel regions 130 defined by two corresponding data lines DL1 has two curving side boundaries, and each of the pixel regions 130 in each row of pixel regions 130 has a curved configuration according to two corresponding of the data lines DL1 to DLm+1. That is, each two adjacent pixel regions 130 in a row are partially staggered, which may weak the impact of the boundary effect therebetween and enable the active matrix LCD obtain better display quality

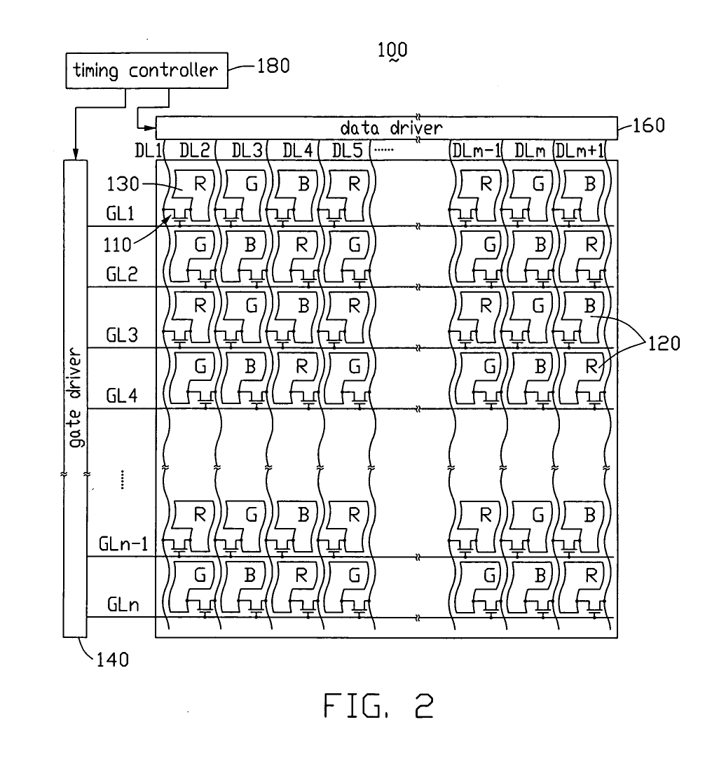

Also referring to FIG. 2, filter elements can be deposited on a horizontal electrode of each pixel region 130 so that a rectangular matrix of filter elements 120 is formed. In each row of the matrix, the colors of the filter elements 120 repeat in the sequence R (red), G (green), and B (blue) from left to right. In each column of the matrix, only two of the three colors R, G, and B alternately repeat in sequence. For example, in a first (leftmost) column, the colors of the filter elements 120 alternately repeat in the sequence R, G; in a second column, the colors of the filter elements 120 alternately repeat in the sequence G, B; and in a third column, the colors of the filter elements 120 alternately repeat in the sequence B, R. Thus, any two adjacent filter elements 120 of any two adjacent columns of filter elements 120 are different from each other. In each row of filter elements 120, the boundary between any two adjacent filter elements 120 (which necessarily have different colors) is wavy, corresponding to the wavy boundary between the corresponding pixel regions 130. This means that for any two adjacent filter elements 120 in each row of filter elements 120, a protruding side portion of a first one of the filter elements 120 protrudes toward a concavity of a second one of the filter elements 120, and vice versa.

With this kind of complementary arrangement, the filter elements 120 of each two adjacent pixel regions 130 in any row of pixel regions 130 are separated by a curved space having a generally uniform width. This can help mitigate the impact of any visual boundary effect that may exist between any two adjacent filter elements 120. Accordingly, the active matrix LCD 100 can provide a better quality display.

In alternative embodiments, each of the data lines DL may have a generally elongated “S” shape, or a series of “S” shapes, or a like configuration. Accordingly, the boundary between any two adjacent filter elements 120 in any row of pixel regions 130 may have a shape corresponding to that of the data lines DL.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display, comprising:
a liquid crystal panel, the liquid crystal panel comprising a plurality of gate lines that are parallel to each other and that each extend along a first direction, and a plurality of data lines that are parallel to each other and that each extend along a second direction substantially orthogonal to the first direction;
a plurality of pixel regions defined by points of intersection of the gate lines and the data lines;
a gate driver for driving the gate lines; and
a data driver for driving the data lines;
wherein each of the data lines comprises curving portions, such that each of the pixel regions defined by two corresponding data lines has two correspondingly curved side boundaries.

2. The liquid crystal display as claimed in claim 1, wherein the curving portions are wavy.

3. The liquid crystal display as claimed in claim 2, further comprising a plurality of filter elements deposited in the pixel regions to form a matrix of filter elements.

4. The liquid crystal display as claimed in claim 3, wherein colors of the filter elements in each of rows of the filter elements repeat in the sequence R (red), G (green), and B (blue) from one end of the row to the other end of the row.

5. The liquid crystal display as claimed in claim 4, wherein a boundary between each two adjacent filter elements is wavy, corresponding to the curved side boundaries of the two pixel regions corresponding to the two adjacent filter elements.

6. The liquid crystal display as claimed in claim 4, wherein each two adjacent filter elements in a row are partially staggered.

7. The liquid crystal display as claimed in claim 3, wherein colors of the filter elements in each of columns of the filter elements alternately repeat in the sequence of a first color and a second color from one end of the column to the other end of the column, and the first and second colors are two colors selected from the group consisting of R (red), G (green), and B (blue).

8. The liquid crystal display as claimed in claim 1, further comprising a timing controller for controlling the gate driver and the data driver.

9. The liquid crystal display as claimed in claim 8, wherein each of the pixel regions further comprises a thin film transistor.

10. The liquid crystal display as claimed in claim 9, wherein each of rows of the thin film transistors connected to an odd-numbered one of the gate lines has a same pattern of connections.

11. The liquid crystal display as claimed in claim 10, wherein the gate line connection of each thin film transistor is from a terminal of the thin film transistor to a corresponding one of the gate lines.

12. The liquid crystal display as claimed in claim 9, wherein each of rows of the thin film transistors connected to an even-numbered one of the gate lines has a same pattern of connections.

13. The liquid crystal display as claimed in claim 12, wherein the gate line connection of each thin film transistor is from a terminal of the thin film transistor to a corresponding one of the gate lines.

14. A liquid crystal display, comprising:
a liquid crystal panel, the liquid crystal panel comprising a plurality of gate lines that are parallel to each other and that each extend along a first direction, and a plurality of data lines that are parallel to each other and that each extend along a second direction with a non-parallel relation with the first direction;
a plurality of pixel regions defined by points of intersection of the gate lines and the data lines;
a gate driver for driving the gate lines; and
a data driver for driving the data lines;
wherein each of the data lines comprises curving portions, such that each of the pixel regions defined by two corresponding data lines has two correspondingly curved side boundaries.
